(19) United States
(12) Patent Application Publication
(10) Pub. No.: US 2007/0090144 A1
(43) Pub. Date: Apr. 26, 2007

(54) CLING WRAP CASE

(75) Inventor: Kazuo Kazama, Sumida-Ku (JP)

Correspondence Address: BURR & BROWN, PO BOX 7068, SYRACUSE, NY, 13261-7068, US

(73) Assignee: Life Two Co., Ltd., Sumida-Ku (JP)

(21) Appl. No.: 11/566,961

(22) Filed: Dec. 5, 2006

Related U.S. Application Data
(62) Division of application No. 11/025,857, filed on Dec. 27, 2004.
Application No. 11/025,857 is a continuation of application No. PCT/JP04/06113, filed on Apr. 28, 2004.

(30) Foreign Application Priority Data
Apr. 28, 2003 (JP) 2003-124127
Oct. 30, 2003 (JP) 2003-370437

(51) Int. Cl. B26F 3/02

(52) U.S. Cl. 225/43

(57) ABSTRACT

A new cling wrap case where even a polyethylene cling wrap film can be easily, assuredly and safely cut off, and concurrently, that is user-friendly, and that enables resource saving generally because this is not disposable but it is repeatably re-usable. This is made form a synthetic resin, and it is equipped with a storage case where a cylindrical cling wrap roll is stored, and a cover, rotatably attached to the storage case, and which can cover over the storage case to be openable, and which concurrently has a cutter member that can cut off a pulled-out cling wrap film; and, the cover is constructed such that when closing the storage case, the pulled-out cling wrap film can be cut off by the cutter member.

### CROSS REFERENCE TO RELATED APPLICATIONS

This application is a division of U.S. application Ser. No. 11/025,857, filed Dec. 27, 2004, which is a continuation of International Application No. PCT/JP2004/006113 having an international filing date of Apr. 28, 2004, which designated the United States, the entireties of which are incorporated herein by reference.

This application also claims the benefit of Japanese Application No. 2003-124127 filed Apr. 28, 2003 and Japanese Application No. 2003-370437 on Oct. 30, 2003, the entireties of which are incorporated herein by reference.

### FIELD OF THE INVENTION

The present invention relates to a cling wrap case with a form where a cling wrap film stored within a case can be used by pulling out and cutting off to a required length as required.

### BACKGROUND OF THE INVENTION

Since this type of cling wrap case that has been conventionally known has construction in which a metal cutter is attached to a cardboard box (refer to Patent Reference 1, the cutter and the cardboard box are thrown away after separating them from each other, which is also troublesome (reference is made, for example, to Japanese Utility Model Publication Hei 07-38129).

Further, the disposable cling wrap case is not preferable for restraining environmental pollution, highlighted as a problem in recent years; for lessening the waste of earth's resources and incineration fuel; and for diminishing the waste collecting cost of each household and local government.

At present, while the environmental problems have been questioned, vinyl chloride has become a general social problem because of the generation of dioxin, so cling wrap made from vinyl chloride is about to be changed to a polyethylene cling wrap.

However, in the case of trying to cut off the polyethylene cling wrap by a conventional cardboard box case cutter, since the polyethylene cling wrap is sticky compared vinyl chloride cling wrap, it is difficult to cut it off, and in the case of forcibly cutting it off, there is a possibility that it may inadvertently cause hand cuts.

Further, when the polyethylene cling wrap is cut off, since the hand is generally rotated and turned toward the user, an end portion of the cut cling wrap film often clings together, so there are many cases in which users cannot smoothly use the cut cling wrap film.

Further, with conventional cling wrap, in the case of pulling out or cutting off the cling wrap film, there is also the problem that fingers touch the cutter, which may easily cause finger cuts.

The objective of the present invention is to resolve the various problems in the background technology. Specifically, the objective is to provide a new cling wrap case that is easily, assuredly and safely used, even for polyethylene cling wrap that is not disposable but which is repeatedly usable for many times; enabling savings of resources.

### SUMMARY OF THE INVENTION

In order to overcome these problems, the cling wrap case of the present invention is made from a synthetic resin; equipped with a storage case where a cylindrical cling wrap roll is stored, and a cover, which is rotatably attached to the storage case, and which can cover the storage case to be openable. Concurrently, it is provided with a cutter that can cut off a pulled-out cling wrap film; constructed such that the pulled-out cling wrap film can be cut off by the cutter member when stopping the storage case.

In other words, in the cling wrap case relating to the present invention, the cling wrap film of a cling wrap roll stored within the storage case becomes usable after pulling it out to a required length and then cutting it off by the cutter member attached to the cover.

Further, the cling wrap case of the present invention is characterized by the fact that the storage case is formed to be a box-state whose upper portion is opened so as to be able to store the cylindrical cling wrap roll; and is constructed such that the cling wrap roll is rotatably supported inside, whereby the cling wrap film can be pulled forward relative to the widthwise direction of the storage case. Concurrently, the cover is secured to the widthwise rear end of the storage case; the cutter member is established at the end of the cover along the rotating direction; a cutter member housing, where the cutter member can be housed when covering the storage case with the cover, is formed at the widthwise front end of the storage case; and it is constructed such that when housing the cutter member in the cutter member housing, a cling wrap film, arranged on the cutter member housing, can be cut off.

In other words, in the cling wrap case relating to the present invention, every time the cling wrap film of the cling wrap roll, stored within the storage case, is pulled out to a required length, the cover is rotated toward the direction of covering the storage case, and housing the cutter member, attached to the cover, in the cutter member housing enables cutting-off the cling wrap film by the cutter member.

The cling wrap case of the present invention is characterized by the fact that the cutter member housing is formed at the upper end of the wall at the widthwise front end side, which comprises the storage case, and the cutter member housing is comprised of a pair of the cutter member housing walls, formed to face each other, at a predetermined interval widthwise.

In other words, in the cling wrap case relating to the present invention, while the cling wrap film is placed on the cutter member housing walls, the cutter member is inserted between a pair of the front & rear cutter member housing walls, cutting the cling wrap film.

Further, the cling wrap case of the present invention is characterized by the fact that cling wrap slip stoppers are established on the upper surface, the upper surface, the front side and the rear side of the rear cutter member housing wall from among a pair of the front & rear cutter member housing walls.

In other words, in the cling wrap case relating to the present invention, when the cling wrap film is cut off by the cutter member, the cling wrap film is secured in a state with predetermined tension by making contact with the slip stoppers, established on the upper surface and the front side of the rear cutter member housing wall.

Further, the cling wrap case of the present invention is characterized by the fact that notches, for the purpose of inserting a user's fingers into the cutter member housing, are formed in a pair of the front and rear cutter member housing walls comprising the cutter member housing, respectively, construction being such that when pulling out the cling wrap film, fingers are inserted into the notches, and the end portion of the cling wrap film can be grasped.

In other words, in the cling wrap case relating to the present invention, after the cling wrap film is cut off, fingers are inserted into the notches, and a cling wrap film, to be cut for the next use, can be pulled out by grasping it with the fingers.

Further, the cling wrap case of the present invention is characterized by the fact that lock mechanisms, which can secure the state where the cover closes the storage case, are established at the lengthwise ends of the storage case and the cover.

In other words, in the cling wrap case relating to the present invention, if it is unnecessary to cut off a cling wrap film, the storage case is stopped by the cover, and the lock mechanisms can secure the stopped state.

Further, the cling wrap case of the present invention is characterized by the fact that cling wrap seizing members, which penetrate through the end walls and are detachable, respectively, are established, and when these are fitted, they are inserted into the tube of the cling wrap roll arranged within the storage case, and hold the cling wrap roll so as to be rotatable. Concurrently, when these are extracted from the end walls, they are released from the tube of the cling wrap roll, and the cling wrap roll becomes extractable from the storage case.

In other words, in the cling wrap case relating to the present invention, fitting or extracting the cling wrap seizing members enables holding or releasing the cling wrap rolls, respectively.

Further, the cling wrap case of the present invention is characterized by the fact that the cutter member is formed to be elongated plate-state, and it is arranged along the lengthwise direction of the cover.

In other words, in the cling wrap case of the present invention, the cutter member has a length sufficient for cutting off the entire widthwise cling wrap film at once.

Further, the cling wrap case of the present invention is characterized by the fact that the cutter member is arranged at the end of the cover in the direction of rotation; a back board is established in the vicinity of the cutter member along the lengthwise direction; the cutting edge of the cutter member is formed to be lower than the end of the front wall, formed at the end of the cover along the rotating direction, and lower than the end of the back board; and it is constructed such that while the cover closes the storage case, the back board pushes the cling wrap film, placed on the cutter member housing walls, downward behind the rear cutter member housing wall.

In other words, in the cling wrap case of the present invention, in the case that a finger is brought close to the cutter member, the finger makes contact with the end of the back board or the end of the front wall, which both protrude outward more than the cutting edge of the cutter member, making it is difficult to bring the finger into contact with the cutting edge.

Further, when the cover is closed, the back board pushes the cling wrap film down, and tension force is applied to the cling wrap film.

Further, the cling wrap case of the present invention is characterized by the fact that stoppers, which can stop the rotation of the cover at a required angle so as not to be fully opened relative to the storage case, are established at positions where the cover and storage case are rotatably connected.

In other words, with the cling wrap case relating to the present invention, when the cover is rotated toward a direction where the upper portion of the storage case is opened at a required angle, the stoppers obstruct the rotation more than the required angle, and it can prevent the cover from fully opening.

Further, the cling wrap case of the present invention is characterized by the fact that ribs, which have cling wrap abrading surfaces that are formed from a curved surface where the cylindrical cling wrap roll can be held to be turnable, respectively, are established.

In other words, in the cling wrap case relating to the present invention, the cling wrap abrading surfaces of the ribs contribute to an easy turn of the cling wrap roll.

Further, the cling wrap case of the present invention is characterized by the fact that the storage case and the cover are made from an ABS resin.

In other words, in the cling wrap case relating to the present invention, since the cling wrap case is made from the ABS resin, in the case of using up the cling wrap film, the cling wrap case does not have to be disposed, but can be used again by replacing it with a new cling wrap roll.

Further, the cling wrap case of the present invention is characterized by the fact that a fastener means due to a magnetic force is established at the back side of the bottom of the storage case.

In other words, in the cling wrap case relating to the present invention, when the cling wrap case is not used, it can be adhered onto a refrigerator, generally, by a fastener means utilizing a magnetic force.

Further, the cling wrap case of the present invention is characterized by the fact that the cling wrap film is made from polyethylene, or polypropylene, or a composite structural material of polyethylene and polypropylene. Therefore, in the cling wrap case relating to the present invention, instead of a cling wrap film made from vinyl chloride, which has many problems as mentioned above, the cling wrap that is made from polyolefin, which has no problems if any, is used.

Further, the cling wrap case of the present invention is characterized by the fact that the cutter member is toothed. Therefore, in the cling wrap case relating to the present invention, the cutter member is sharp.

The cling wrap case of the present invention is made from a synthetic resin; and is equipped with a storage case where a cylindrical cling wrap roll is stored, and the cover which is rotatably attached to the storage case, can cover the storage case so as to be openable. Concurrently, which has the cutter member that can cut off a pulled-out cling wrap film; and, the cover is constructed such that when closing the storage case, a pulled-out cling wrap film can be cut off by the cutter member when the cover rotating.

Therefore, in the case of cutting off the cling wrap film, it is unnecessary to rotate a hand as with the conventional cling wrap case, so the operation is easy. Further, if a hand is rotated as with the conventional cling wrap case, in the case of cutting off a cling wrap film, there is the defect that the cling wrap film may cling together. However, there is no such defect with the cling wrap case of the present invention.

In the cling wrap case of the present invention, the storage case is formed to be box-state whose upper portion is open so as to be able to store the cylindrical cling wrap roll; and is constructed such that the cling wrap roll is rotatably supported inside, and the cling wrap film can be pulled forward relative to the widthwise direction of the storage case. Therefore, the cling wrap roll is easily stored within the storage case, and the cling wrap film can be easily pulled out forward from the storage case.

Further, the cover is secured to the widthwise rear end of the storage case; the cutter member is established at the end of the cover along the direction of rotation; the cutter member housing, where the cutter member can be housed when covering the storage case with the cover, is formed at the widthwise front end of the storage case; and is constructed such that when housing the cutter member in the cutter member housing, the cling wrap film arranged on the cutter member housing, can be cut off. Therefore, rotating the cover and housing the cutter member attached to the cover, in the cutter member housing enable cutting of the cling wrap film, so operation is easy and safe, and the cling wrap film can be assuredly cut off.

Further, in the cling wrap case of the present invention, the cutter member housing is formed at the upper end of the wall at the widthwise front end side, which comprises the storage case, and the cutter member housing is comprised of a pair of the cutter member housing walls, formed to face each other, at pre-determined intervals widthwise, and while the cling wrap film is placed on the cutter member housing walls, the cutter member is inserted between a pair of the front and rear cutter member housing walls and the cling wrap film is cut off. Therefore, the cling wrap film to be cut off by the cutter member is placed between the upper surface of a pair of the cutter member housing walls with a tension force, so the cutting of the cling wrap film by the cutter member is easy and sure.

Further, in the cling wrap case of the present invention, cling wrap slip stoppers are established on the upper surface, the front side and the rear side of the rear cutter member housing wall out of a pair of the front and rear cutter member housing walls, and when the cling wrap film is cut off by the cutter member, the cling wrap film is secured in the state with a predetermined tension by making contact with the slip stoppers, established on the upper surface and the front side of the rear cutter member housing wall. Therefore, the cling wrap film maintains the tension state and the cutting-off by the cutter member is easy. Further, even after the cling wrap film has been cut off, since the end of the cling wrap film to be pulled out for next use is held at the slip stoppers, it is easy to pull it out.

Further, in the cling wrap case of the present invention, notches for the purpose of inserting a user's fingers into the cutter member housing are formed in a pair of the front and rear cutter member housing walls comprising the cutter member housing, respectively, and when pulling out the cling wrap film, fingers are inserted into the notches, and the end portion of the cling wrap film can be grasped, so after the cling wrap film is cut off, fingers are inserted into the notches, and a cling wrap film, which will be cut for the next usage, can be pulled out by grasping with the fingers, making it user-friendly.

Further, in the cling wrap case of the present invention, since the lock mechanisms, which can secure the state where the cover closes the storage case, are established at the lengthwise ends of the storage case and the cover, if it is unnecessary to cut off a cling wrap film, the storage case is closed by the cover, and the lock mechanisms can secure the closed state, preventing the cover from easily opening and preventing the stored cling wrap roll from slipping out, and preventing the cling wrap from becoming dirty.

Further, in the cling wrap case of the present invention, the cling wrap seizing members, which penetrate through the end walls and which are detachable, respectively, are established, and when these are fitted, they are inserted into the tube of the cling wrap roll, arranged within the storage case, and rotatably hold the cling wrap roll. Concurrently, when these are extracted from the end walls, they are released from the tube of the cling wrap roll, and the cling wrap becomes extractable from the storage case. Therefore, fitting or releasing the cling wrap seizing members enables holding or extracting of the cling wrap roll, respectively, so the cling wrap roll can be easily and promptly replaced.

Further, in the cling wrap case of the present invention, since the cutter member is formed to be an elongated plate-state and is arranged along the lengthwise direction of the cover, the entire widthwise cling wrap film can be cut off at once, making it is easy to cut off the cling wrap film.

Further, in the cling wrap case of the present invention, the cutter member is arranged at the end of the cover along the rotating direction; a back board is established in the vicinity of the cutter member along its lengthwise direction; the cutting edge of the cutter member is formed to be lower than the end of the front wall, formed at the end of the cover along the rotating direction, and lower than the end of the back board; and is constructed such that while the cover closes the storage case, the back board pushes the cling wrap film, which is placed on the cutter member housing walls, downward behind the rear side cutter member housing wall. Therefore, if a finger is brought close to the cutter member, the fingers make contact with the end of the back board or the end of the front wall, which both protrude outward more than the cutting edge of the cutter member, and it is difficult to bring the fingers into contact with the cutting edge, so it is difficult to become injured.

Further, when the cover is closed, the back board pushes the cling wrap film down, and tension force is applied to the cling wrap film, making it easy to cut off the cling wrap film with the cutter member.

Further, in the cling wrap case of the present invention, since the stoppers, which can stop the rotation of the cover at a required angle so as not to be fully open relative to the storage case, are established at the positions where the cover and storage case are connected so as to be rotatable, when the cover is rotated in a direction where the upper portion of the storage case is opened at a required angle, the stoppers obstruct the rotation more than the required angle, preventing the cover from fully opening. In the case of performing the cutting operation of the cling wrap film when holding it by hand, it is easy for a user with small hands to hold it, and the cutting operation is easy.

Further, in the cling wrap case of the present invention, since ribs which have cling wrap abrading surfaces that are formed from a curved surface where the cylindrical cling wrap roll can be rotatably held, are respectively established, the cling wrap abrading surfaces of the ribs contribute to an easily turning the cling wrap roll, and the cling wrap film can be smoothly pulled out.

Further, in the cling wrap case of the present invention, since the storage case and the cover are made from ABS resin, when using up the cling wrap film, the cling wrap case need not be disposed but can be used again by replacing it with a new cling wrap roll. Therefore, the present invention can contribute to the effective utilization of resources. Further, since they are made from the ABS resin, dirt/stain that adhering on the surface can be easily removed, and the tidiness can be maintained. Further, design printing can be easily performed.

Further, in the cling wrap case of the present invention, since the fastener means is magnetically established at the back surface side of the bottom of the storage case, when it is not used, it can be magnetically adhered onto a refrigerator, making storage convenient.

Further, in the cling wrap case of the present invention, since the cling wrap film is made from polyethylene, or polypropylene, or a composite structural material of polyethylene and polypropylene, when incinerated, it does not generate any harmful substance such as dioxin, as does vinyl chloride cling wrap film, preventing environmental pollution.

Further, in the cling wrap case of the present invention, since the cutter member is toothed, the cutter member is sharp, and the cling wrap film can be smoothly cut off, and the cut end is also fine.

### BRIEF DESCRIPTION OF THE DRAWINGS

FIG. 1 is a perspective view that shows the situation where the cover is opened;

FIG. 2 is a cross sectional view that shows the state where the cover is opened;

FIG. 3 is a perspective view that shows the state where the cover is closed;

FIG. 4 is a cross sectional view that shows the state where the cover is opened;

FIG. 5 is a cross sectional view that shows the state where the cling wrap is held by the cling wrap seizing members;

FIG. 6 is a cross sectional view that shows the state where the cling wrap seizing members are detached from the cling wrap;

FIG. 7 is a cross sectional view that shows the state where the cover is closed and it is locked;

FIG. 8 is a cross sectional view that shows the state where the cover is closed; and

FIG. 9 is a cross sectional view that shows the state where the cover is opened and it is stopped at a predetermined angle by the stoppers.

### DETAILED DESCRIPTION OF THE INVENTION

An embodiment of the present invention is explained hereafter, with reference to the drawings.

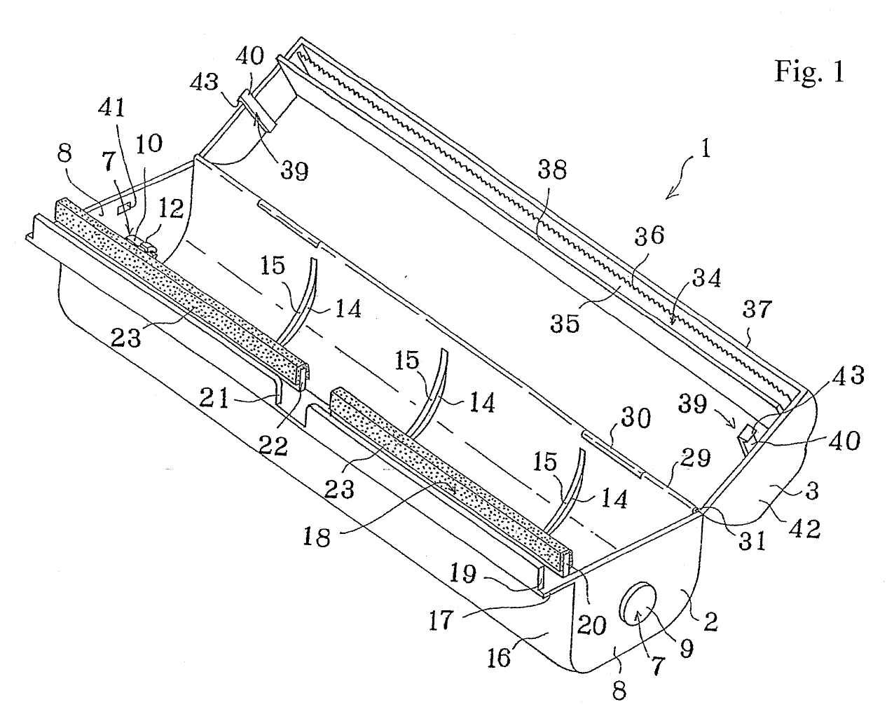

First, the cling wrap case 1 relating to the present invention is made from a synthetic resin, and as shown in FIG. 1 through FIG. 4, it is equipped with a storage case 2 where a cylindrical cling wrap roll 4 is stored, and a cover 3, which is rotatably attached to the storage case 2, and which can cover over the storage case 2 to be openable. Concurrently, it has a cutter member 34 that can cut off a pulled-out cling wrap film 5; the cover 3 being constructed such that when closing the storage case 2, the pulled-out cling wrap film 5 can be cut off by the cutter member 34.

Further, the storage case 2, as shown in FIG. 1 through FIG. 4, is formed to be a box-state whose upper portion is opened so as to be able to store the cylindrical cling wrap roll 4; and is constructed such that the cling wrap roll 4 is rotatably supported inside, the cling wrap film 5 being pulled out forward relative to the widthwise direction of the storage case 2. Concurrently, the cover 3 is secured to the widthwise rear end of the storage case 2; the cutter member 34 is established at the end of the cover 3 along the rotating direction; a cutter member housing 18, where the cutter member 34 can be housed when covering the storage case 2 with the cover 3, is formed at the widthwise front end of the storage case 2; and it is constructed such that when housing the cutter member 34 in the cutter member housing 18, the cling wrap film 5, which is arranged on the cutter member housing 18, can be cut off.

Further, the cutter member housing 18, as shown in FIG. 1 through FIG. 4, is formed at the upper end of the wall 16 at the widthwise front end side, which comprises the storage case 2, comprising a pair of the cutter member housing walls 19 and 20 formed to face each other, at a predetermined interval widthwise.

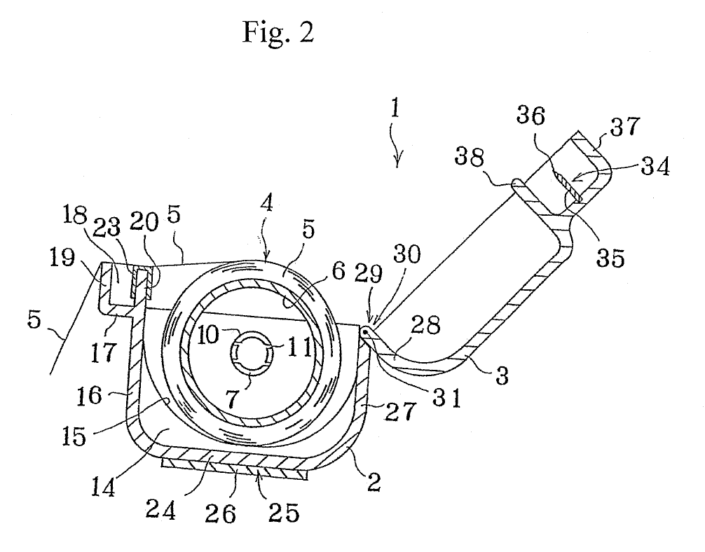

Further, as shown in FIG. 1 and FIG. 2, cling wrap slip stoppers 23 are established on the upper surface, the front side and the rear side of the rear cutter member housing wall 20 out of a pair of the front & rear cutter member housing walls 19 and 20.

As shown in FIG. 1, notches 21 and 22, for the purpose of inserting a user's fingers into the cutter member housing 18, are formed in a pair of the front and rear cutter member housing walls 19 and 20 that comprise the cutter member housing 18, respectively, construction being such that when pulling out the cling wrap film 5, fingers are inserted into the notches 21 and 22, and the end of the cling wrap film 5 can be grasped.

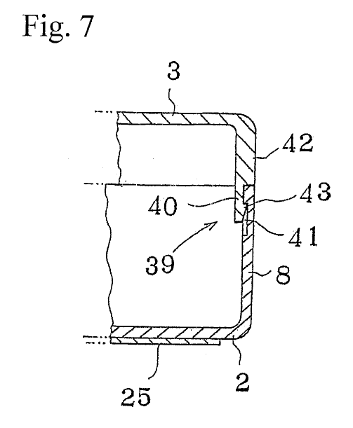

Further, as shown in FIG. 1 and FIG. 7, lock mechanisms 39, which can secure the state where the cover 3 closes the storage case 2, are established at the lengthwise end of the storage case 2 and the cover 3.

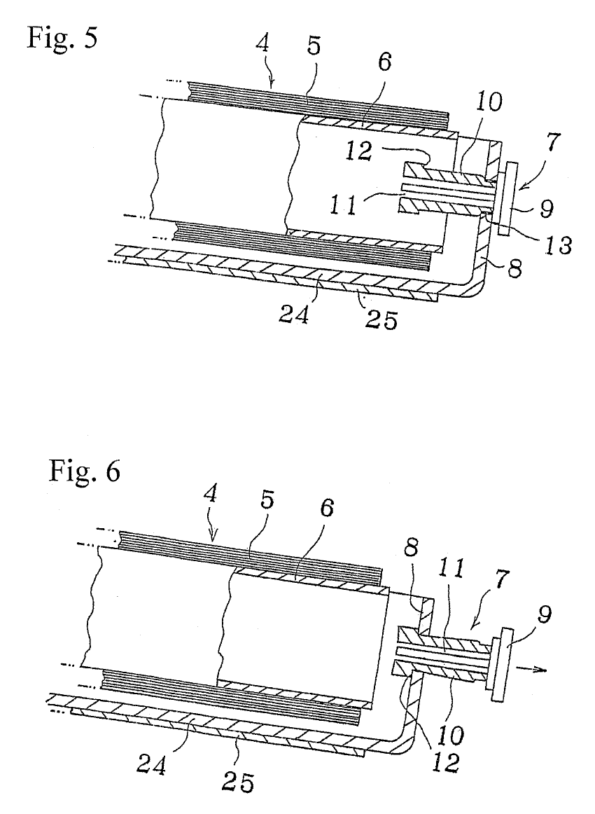

Further, as shown in FIG. 1, FIG. 5 and FIG. 6, cling wrap seizing members 7, which penetrate through the end walls and are detachable, respectively, are established, and where these are fitted, they are inserted into a tube 6 of the cling wrap roll 4, arranged within the storage case 2, and they rotatably hold the cling wrap roll 4. Concurrently, when these are extracted from the end walls 8, they are released from the tube 6 of the cling wrap roll 4, and the cling wrap roll 4 becomes extractable from the storage case 2.

Further, as shown in FIG. 1, the cutter member 34 is formed to be an elongated plate, and it is arranged along the lengthwise direction of the cover 3.

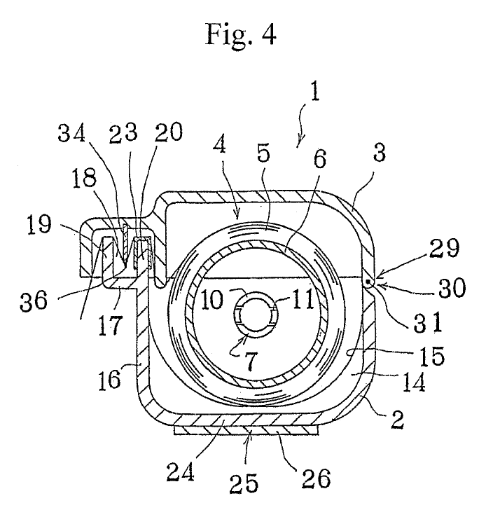

Further, as shown in FIG. 1, FIG. 2 and FIG. 4, the cutter member 34 is arranged at the end of the cover 3 along the rotating direction; a back board 38 is established in the vicinity of the cutter member 34 along its lengthwise direction; the cutting edge of the cutter member 34 is formed lower than the end of a front wall 37, formed at the end of the cover 3 along the rotating direction, and lower than the end of the back board 38; and the back board 38 is constructed to push down the cling wrap film 5 placed on the cutter member housing walls 19 and 20, downward behind the rear cutter member housing wall 20 while the cover 3 closes the storage case 2.

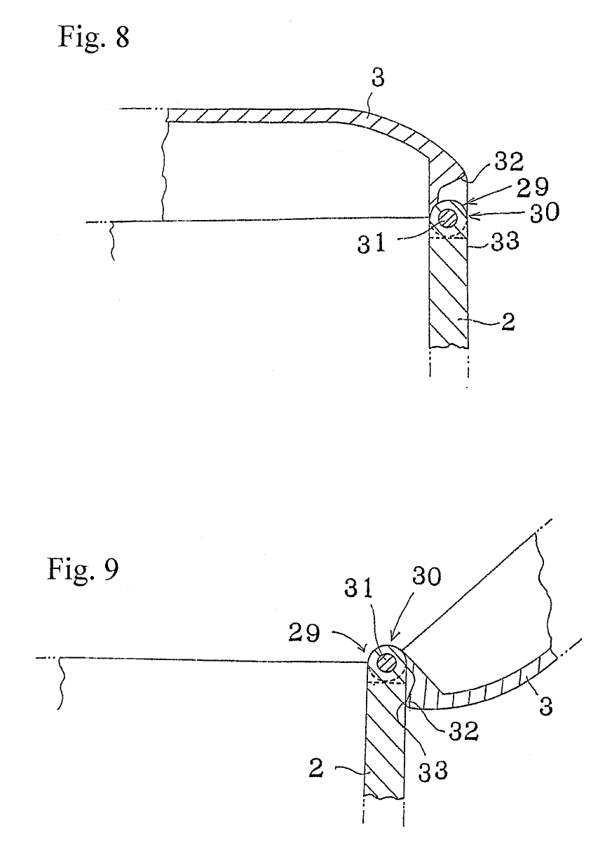

Further, as shown in FIG. 8 and FIG. 9, stoppers 32 and 33, which can stop the rotation of the cover 3 at a required angle so as not to be fully opened relative to the storage case 2, are established at the positions where the cover 3 and the storage case 2 are rotatably connected.

As shown in FIG. 1 and FIG. 2, ribs 14, which have cling wrap abrading surfaces 15 formed from a curved surface where the cylindrical cling wrap roll 4 can be held so as to be turnable, respectively, are established.

Further, the storage case 2 and the cover 3 are molded from the ABS resin. Further, as shown in FIG. 2 and FIG. 4, a fastener means 25 is magnetically established at the back surface side of the bottom of the storage case 2. Further, the cling wrap film 5 is formed from polyethylene, or polypropylene, or a composite material of polyethylene and polypropylene. Further, the cutter member 34 is toothed.

Illustrated embodiments of the present invention are explained next.

First, the cling wrap case 1 relating to the present invention, as shown in FIG. 1 and FIG. 2, is constructed by establishing the storage case 2 and the cover 3, and both the storage case 2 and cover 3 are molded from a synthetic resin, specifically, from the ABS resin.

The storage case 2, as shown in FIG. 1 and FIG. 2, stores the cylindrically-formed cling wrap roll 4 and holds it. Concurrently, it is formed to be horizontally long box-like whose upper portion is opened, so as to be able to pull out the cling wrap film 5.

Furthermore, the cling wrap roll 4, as shown in FIG. 2 and FIG. 4, is constructed by wrapping the cling wrap film 5 around the external circumference of the tube 6, formed to be cylindrical from cardboard. Then, the cling wrap film 5 is formed from polyethylene, or polypropylene or a composite material of polyethylene and polypropylene. The conventional vinyl chloride cling wrap film generates a toxic substance, such as dioxin, in the case of incineration. However, this cling wrap film 5, formed from polyethylene generally, does not generate any toxic substance even when it is incinerated, preventing environmental pollution.

The cling wrap roll 4 that is stored within the storage case 2, as shown in FIG. 1, FIG. 5 and FIG. 6, is held by seizing with cling wrap seizing members 7 so as not to slip out. The cling wrap seizing members 7 are attached to the end walls 8, formed at both lengthwise ends of the storage case 2.

The cling wrap seizing members 7, as shown in FIG. 1, FIG. 5 and FIG. 6, have disc-state heads 9 and cylinders 10, which project inward from the heads 9, respectively, the cylinders 10 being formed so as to be easily elastically deformed, and seizing parts 12 are established on the external surfaces of the end of the cylinders 10, respectively.

In the cling wrap seizing members 7, as shown in FIG. 1, FIG. 5 and FIG. 6, the heads 9 are arranged at the external surface sides of the end walls 8, formed at both lengthwise ends of the storage case 2, and the cylinders 10 are fitted in a state which penetrates through holes 13, formed in the end walls 8, respectively.

Construction is such that the cylinders 10 of the cling wrap seizing member 7 are movable inward and outward relative to the holes 13, respectively. When these are moved outward, the seizing parts 12 seize at the edge of the holes 13 at the internal surface sides of the end walls 8, preventing the cylinders 10 from slipping out, and if the cylinders 10 are reduced toward the radical direction, the seizure by the seizing parts 12 is disengaged, and the seizing parts 12 become passable through the holes 13, and the cling wrap seizing members 7 become removable from the end walls 8, respectively.

When the cling wrap roll 4 is stored within the storage case 2; the cling wrap seizing members 7 are fitted to the end walls 8, respectively; and when the cylinders 10 are moved inward, the cylinders 10 are inserted into the inside of the tube 6 of the cling wrap roll 4, and the cling wrap roll 4 is held so as not to be released from the storage case 2.

Conversely, if the cylinders 10 are extracted from the end walls 8, the cling wrap roll 4 becomes free and extractable from the storage case 2. Furthermore, the dimension has been established so as to be able to extract the cling wrap roll 4 even if the cylinders 10 are moved outward and these become in the state where the seizing parts 12 are still seized at the edges of the holes 13 at the internal surface side of the end walls 8, respectively.

In the case of pulling out the cling wrap film 5 of the cling wrap roll 4, which is stored within the storage case 2, the cling wrap roll 4 turns. Therefore, if the cling wrap roll 4 does not smoothly turn, it obstructs the pulling-out of the cling wrap film 5. Then, the ribs 14 for the purpose of easily turning the cling wrap roll 4 are formed widthwise at multiple lengthwise places on the bottom surface of the storage case 2.

The ribs 14 have the cling wrap abrading surfaces 15, which can support the cylinder cling wrap roll 4 to allow to the roll to be turnable and are formed from a curved surface, respectively.

Furthermore, the ribs 14 can be formed such that the height dimension of the widthwise rear side of the storage case 2 shall be greater than that of the widthwise front side. In this case, the cling wrap roll 4 are arranged in a state where they always protrude forward due to the difference of the height of the ribs within the storage case 2, so any rewind will never occur backward along the widthwise direction of the storage case 2, and the pulling-out of the cling wrap film 5 becomes easier for next use.

As shown in FIG. 1 and FIG. 2, a jaw plate 17, which protrudes forward, is established at the widthwise front end of the storage case 2, in other words, at the upper end of the front wall 16 in the storage case 2, and the cutter member housing 18 is established on the jaw plate 17.

The cutter member housing 18, as shown in FIG. 1 and FIG. 2, is comprised of a pair of the front & rear cutter member housing walls 19 and 20 that are vertically arranged in parallel. These cutter member housing walls 19 and 20 are formed along the lengthwise direction at the upper surface side of the jaw plate 17, and the notches 21 and 22 with a width where fingers can be inserted, as shown in FIG. 1 and FIG. 2, are formed in the lengthwise center, respectively.

Therefore, the insertion of fingers into the notches 21 and 22 enables easy pulling-out of the cling wrap film 5 of the cling wrap roll 4, which is stored within the storage case 2, by grasping with fingers.

The cling wrap slip stoppers 23, as shown in FIG. 1 and FIG. 2, are established on the upper surface, the front side and the rear side of the cutter member housing wall 20, which is positioned behind widthwise in the cutter member housing 18.

The cling wrap slip stoppers 23 are formed by adhering a sheet-state material, in the present embodiments. The cling wrap slip stoppers 23 that are formed to be sheet-state have a structure where an elastic ABS resin, which demonstrates an extremely high non-slip property even with a minute load, is laminated onto a synthetic rubber padding containing a carbon ceramic.

Furthermore, the cling wrap slip stoppers 23 can also be established by applying an adhesive capacity substance.

Further, a plastic plate containing a powder magnet 26, as shown in FIG. 2 and FIG. 4, is adhered onto the back surface side of the bottom plate 24 of the storage case 2 as the fastener means 25 utilizing a magnetic force. Therefore, in the case of not using this cling wrap case 1, it can be stored by adhering onto a refrigerator, generally.

Further, the cover 3, as shown in FIG. 1 through FIG. 4, is formed to be horizontally long box-state so as to be able to cover the upper portion of the storage case 2, and its widthwise rear end is rotatably connected to the widthwise rear end of the storage case 2. In other words, hinges 29 and 30 are formed at the upper end of the rear wall 27 in the storage case 2, and at the lower end of the rear wall 28 of the cover 3 along the lengthwise direction, respectively, and the insertion of a central rotation axis 31 into these hinges 29 and 30 results in the rotatable connection of the cover 3 and the storage case 2.

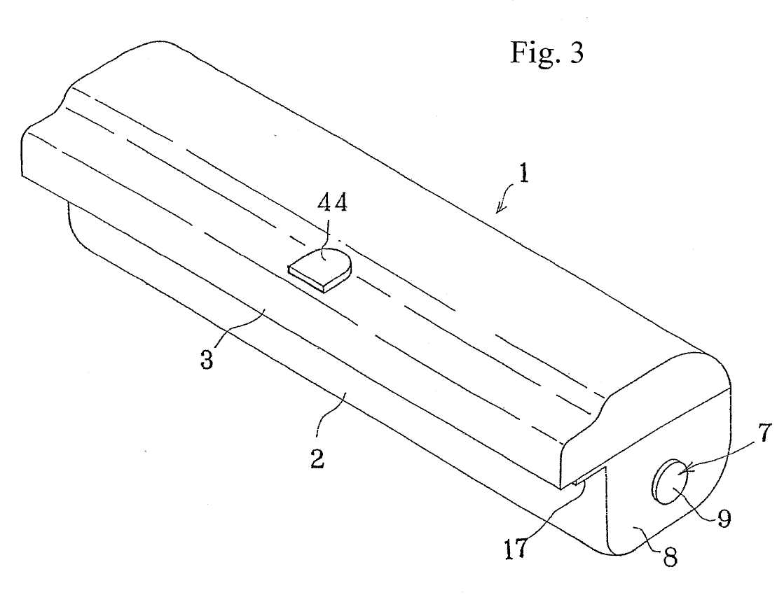

In other words, it is constructed such that rotating of the cover 3 forward, as shown in FIG. 3 and FIG. 4, results in covering & closing the upper portion of the storage case 2. Conversely, rotating backward results in opening the upper portion of the storage case 2.

The stoppers 32 and 33, which can stop the rotating at approximately 135° from the close state, are established, as shown in FIG. 8 and FIG. 9, at the positions where the cover 3 and the storage case 2 are rotatably connected, so as not to fully open the cover 3 relative to the storage case 2. Furthermore, the configuration and the structure of these stoppers 32 and 33 are various, and are not be limited to that which is illustrated.

Further, as shown in FIG. 1 through FIG. 4, the cutter member 34 is established at the end of the cover 3 along the rotating direction, in other words, at the widthwise front end. This cutter member 34 is formed by establishing a serration 36 along the one side edge of a narrow metal plate 35, and the serration 36 is toothed.

The cutter member 34, as shown in FIG. 1, is arranged lengthwise, slightly behind the front wall 37 in the cover 3, and its anchor extremity is fixed to the cover 3.

As shown in FIG. 3 and FIG. 4, when the cover 3 is rotated forward and it covers and closes over the storage case 2, the cutter member 34 is arranged so as to be inserted into the cutter member housing 18 from the upper portion, and so as to be positioned between a pair of the cutter member housing walls 19 and 20.

The back board 38 is established in the lengthwise direction of the cutter member 34, as shown in FIG. 1 through FIG. 4, at the front end of the cover 3 and slightly behind the cutter member 34.

The end of the back board 38 is formed so as to be protruded outward more than the cutting edge of the cutter member 34. Further, the end of the front wall 37 in the cover 3 is also formed so as to be protruded outward more than the cutting edge of the cutter member 34. In other words, the cutting edge of the cutter member 34 is formed to be lower than the end of the back board 38 and the end of the front wall 37.

Therefore, in the case that a finger is brought close to the cutting edge of the cutter member 34 while the cover 3 is opened, the finger makes contact with the end of the back board 38 or the end of the front wall 37, and any contact of the cutting edge of the cutter member 34 by the finger can be prevented. This enables the prevention of finger cuts by touching the cutting edge, and the safety can be enhanced.

Further, the back board 38, as shown in FIG. 4, has a function to push down the cling wrap film 5, placed on the cutter member housing walls 19 and 20, from top to bottom behind the rear side of the cutter member housing wall 20 when the cover 3 is rotated forward and covers and closes over the storage case 2, enabling the application of a tension force to the cling wrap film 5.

As shown in FIG. 1 and FIG. 7, the lock mechanisms 39, for the purpose of securing the state where the cover 3 is rotated forward and it covers and closes over the storage case 2, are established.

The lock mechanisms, as shown in FIG. 1 and FIG. 7, are comprised of lock pieces 40 and seizing grooves 41, respectively. For the lock pieces 40, their ends are established so as to protrude from the end walls 42, which are at both lengthwise ends of the cover 3, respectively, and the seizing grooves 41 are formed on the internal surfaces of the end walls 8, which are at both lengthwise ends of the storage case 2, respectively.

While the cover 3 is rotated forward and covers & closes over the storage case 2, it is constructed such that the engagements of end hooks 43 of the lock pieces 40 with the seizing grooves 41 result in the locked state, respectively.

A knob 44 is established at the widthwise front end on the external surface of the cover 3, as shown in FIG. 3, for the purpose of easily opening the cover 3 by grasping with fingers.

The cling wrap case 1 relating to the present invention is used as follows:

As shown in FIG. 1 and FIG. 2, the cover 3 is rotated backward and it results in the opening of the upper portion of the storage case 2, and while the cling wrap seizing members 7 are extracted from the end walls 8 of the storage case 2, respectively, or the cling wrap seizing members 7 are moved outward, the cylindrical cling wrap roll 4 is stored inside the empty storage case 2.

In this case, while the cover 3 is opened, the cover 3 is secured so as not to be fully opened by the stoppers 32 and 33, so even a user with small hands can easily hold the cling wrap case 1, and it is also easily operable.

Further, as mentioned above, while the cover 3 is opened, when a hand is brought close to the cutter member 34, which is attached to the cover 3, the hand touches the end of the back board 38 or the end of the front wall 37, so touching the cutter member 34 by hand is prevented. Therefore, it prevents hurting the hand.

Next, the fitting of the cling wrap seizing members 7 to the end walls 8, respectively, or the movement of the cling wrap seizing members 7 inward results in the insertion the cylinders 10 of the cling wrap seizing members 7 into the inside of the tube 6 of the cling wrap roll 4, respectively. This results in the completion to load the cling wrap roll 4 into the storage case 2, and the cling wrap roll 4 is held within the storage case 2 so as not to be releasable.

In the case of using the cling wrap film 5 by cutting to a required length, as shown in FIG. 2, the required length of the cling wrap film 5 is pulled out from the cling wrap roll 4, and the portion of the cling wrap film 5 to be cut is placed on a pair of the front and rear above-mentioned cutter member housing walls 19 and 20, which comprise the cutter member housing 18. At this time, the cling wrap film 5 makes contact with the cling wrap slip stoppers 23 and is secured.

Next, the cover 3 is rotated forward, and as shown in FIG. 3 and FIG. 4, it covers and stops over the case 2. When this operation is performed, while the back board 38 pushes the cling wrap film 5 downward behind the rear side of the rear cutter member housing wall 20 and a tension force is applied, the cutter member 34 is inserted in between a pair of the front and rear cutter member housing walls 19 and 20, which comprise the cutter member housing 18, and the cling wrap film 5 is cut off.

In this case, the cut edge of the cling wrap film 5 makes contact with the cling wrap slip stoppers 23, arranged on the upper surface, the front side and the rear side of the rear cutter member housing wall 20, and it is secured, so the cling wrap roll 4 will never be rewound.

In addition, in the case of using the cling wrap film 5 by cutting to a required length, the cover 3 is opened and the cut edge of the cling wrap film 5, which makes contact with the cling wrap slip stoppers 23 that are arranged on the upper surface, the front side and the rear side of the cutter member housing wall 20 and is secured, is pulled out by grasping with fingers, and, it that case, the insertion of fingers into the notches 21 and 22, which are formed in the cutter member housing walls 19 and 20, respectively, enables the easy grasp and pulling out.

In the case that the cling wrap film 5 is used up and the cling wrap roll 4 is replaced with a new one, while the cling wrap seizing members 7 are extracted from the edge walls 8 of the storage case 2, or while the cling wrap seizing members 7 are moved outward, the cling wrap roll 4 can be easily replaced.

In the case of not using the cling wrap case 1, it is stored in the state where the cover 3 is closed. In this case, since the closed state of the cover 3 is secured by the lock mechanisms 39 and they can prevent the cover 3 from easily opening, they prevent the cling wrap roll 4 from slipping off or becoming dirty.

In the case of storage, the cling wrap case 1 can be stored by adhering onto frequently-used equipment, such as a refrigerator, using the fastening means 25 where a magnetic force is utilized, attached at the back surface side of the bottom 24 of the storage case 2.

As explained above, the present invention can be adopted for a cling wrap case where a polyethylene cling wrap can be easily, assuredly and safely cut off. Concurrently, it can be adopted to a cling wrap case that is used by storing a cling wrap film within a case.

What is claimed:

1. A cling wrap case comprising:
a synthetic resin storage case formed in a longitudinally extending box shape having an open upper portion and being adapted to rotatably support a cylindrical cling wrap roll inside the storage case such that a cling wrap film can be dispensed from the cling wrap roll in a widthwise direction of the storage case;
a cover adapted to close the upper portion of the storage case, the cover having a first side that is rotatably secured to a first longitudinally extending side of the storage case;
a cutter member located along an opposed, second side of the cover;
a back board located on the cover adjacent the cutter member and extending substantially along the length of the cutter member, wherein a cutting edge of the cutter member is recessed with respect to the second side of the cover and with respect to the back board;
a cutter member housing extending along an opposed, second longitudinally extending side of the storage case adjacent the upper portion of the storage case, the cutter member housing comprising first and second cutter member housing walls spaced from one another by a predetermined distance, the first cutter member housing wall being positioned adjacent the inside of the storage case;
cling wrap slip stoppers located on upper and side surfaces of the first cutter member housing wall; and
at least one detachable seizing member located in a laterally extending side of the storage case,
wherein during dispensing of the cling wrap film, the cling wrap film is positioned on the cutter member housing walls, the cover is closed such that the cling wrap film is pushed downward by the back board behind the first cutter member housing wall, and the cutter member is positioned between the first and second cutter member housing walls, whereby the dispensed portion of the cling wrap film is cut from the remaining cling wrap film on the cling wrap roll within the storage case, and
wherein the cling wrap roll is held within the storage case when the cling wrap seizing member is inserted into a tube of the cling wrap roll arranged within the storage case and the cling wrap rolls become extractable from the storage case when the cling wrap seizing member is extracted from the tube of the cling wrap roll.

2. The cling wrap case according to claim 1, further comprising at least one notch formed in the first and second cutter member housing walls, wherein, during dispensing of the cling wrap film, an end portion of the cling wrap film can be grasped by inserting a finger into the notch.

3. The cling wrap case according to claim 1, further comprising at least one lock mechanism located on a laterally extending side of the storage case and the cover.

4. The cling wrap case according to claim 1, wherein the cutter member is an elongated flat plate.

5. The cling wrap case according to claim 1, further comprising at least one stopper located at a position where the cover and storage case are rotatably connected, wherein a rotation of the cover is stopped at a specified angle so that the cover is not fully opened relative to the storage case.

6. The cling wrap case according to claim 1, further comprising a plurality of curved ribs formed on an interior surface of the storage case, the ribs having cling wrap abrading surfaces.

7. The cling wrap case according to claim 1, wherein the synthetic resin is an ABS resin.

8. The cling wrap case according to claim 1, further comprising magnetic fastener means located along an outer surface of a third longitudinal side of the storage case located between the first and second longitudinal sides.

9. The cling wrap case according to claim 1, wherein the cling wrap film is made from one of polyethylene, polypropylene, and a composite structural material of polyethylene and polypropylene.

10. The cling wrap case according to claim 1, wherein the cutter member is serrated.

11. The cling wrap case according to claim 1, wherein the back board and the second side of the cover are connected to one another by a longitudinally extending top portion of the cover, each of the back board and the second side of the cover have a protruding end extending parallel to the cutting edge of the cutter member, the protruding end of the back board extending a distance further from the top portion than the protruding end of second side of the cover and a distance further than the cutting edge, and the protruding end of the second side of the cover extending a distance further than the cutting edge.
